(19) United States
(12) Patent Application Publication
(10) Pub. No.: US 2010/0325466 A1
(43) Pub. Date: Dec. 23, 2010

(54) DISPLAY PANEL DRIVE CIRCUIT, LIQUID CRYSTAL DISPLAY DEVICE, AND METHOD FOR DRIVING DISPLAY PANEL

(76) Inventors: Yuuki Ohta, Osaka (JP); Hideki Morii, Osaka (JP); Akihisa Iwamoto, Osaka (JP); Takayuki Mizunaga, Osaka (JP); Masahiro Hirokane, Osaka (JP)

Correspondence Address: HARNESS, DICKEY & PIERCE, P.L.C., P.O. BOX 8910, RESTON, VA, 20195, US

(21) Appl. No.: 12/735,708

(22) PCT Filed: Dec. 4, 2008
(86) PCT No.: PCT/JP2008/072041

§ 371 Date: Aug. 11, 2010

(30) Foreign Application Priority Data
Mar. 19, 2008 (JP) 2008-072418

(51) Int. Cl. G06F 1/04; G06F 1/12; G02F 1/1333

(52) U.S. Cl. 713/400; 713/500; 349/56

(57) ABSTRACT

In at least one embodiment, a display panel drive circuit including a shift register including unit circuits connected in cascade, each of the unit circuits outputting a signal line selection signal, is configured such that: each of the unit circuits receives a clock signal and either a signal line selection signal outputted from another-stage unit circuit or a start pulse signal; and the clock signal has a rising portion which is caused by activation of the clock signal and which is sloped or a falling portion which is caused by activation of the clock signal and which is sloped. With the configuration, it is possible to realize a display panel drive circuit and a display panel driving method each of which hardly causes a poor gate-on pulse signal (which causes unevenness in electric potential during inactivation, for example.

### TECHNICAL FIELD

The present invention relates to a drive circuit and a driving method for a display panel (for example, a liquid crystal panel).

### BACKGROUND ART

FIG. 13 is a circuit diagram illustrating a conventional shift register for use in a gate driver of a liquid crystal display device. As illustrated in FIG. 13, a conventional shift register 100 includes a plurality of shift circuits (unit circuits) sc1, sc2, scm, and scd, which are connected in cascade. Each shift circuit sci (i=1; 2, 3, . . . , m) includes input nodes qfi, qbi and CKAi, and an output node qoi. In the meantime, the shift circuit scd, which is a dummy, includes input nodes qfd and CKAd, and an output node qod.

The shift circuit sc1 is so configured that: a node qf1 is connected to an output end of a gate start pulse signal GSP; a node qb1 is connected to a node qo2 of the shift circuit sc2; a node CKA1 is connected to a first clock line CKL1 from which a first clock signal is supplied; and a node qo1 outputs a gate-on pulse signal (signal line selection signal) g1. Further, the other shift circuit sci (i=2, 3, . . . , m−1) is so configured that: the node qfi is connected to a node qo(i−1) of a shift circuit sc(i−1); the node qbi is connected to a node qo(i+1) of a shift circuit sc(i+1); the node CKAi is connected to the first clock line CKL1 or a second clock line CKL2 from which a second clock signal is supplied; and the node qoi outputs a gate-on pulse signal (signal line selection signal) gi. When i is an odd number, the node CKAi is connected to the first clock line CKL1. When i is an even number, the node CKAi is connected to the second clock line CKL2.

The shift circuit scm is so configured that: a node qfm is connected to a node qo(m−1) of a shift circuit sc(m−1); a node qbm is connected to the node qod of the dummy shift circuit scd; a node CKAm is connected to the first clock line CKL1 or the second clock line CKL2; and a node qom outputs a gate-on pulse signal (signal line selection signal) gm. When m is an odd number, the node CKAm is connected to the first clock line CKL1. When m is an even number, the node CKAm is connected to the second clock line CKL2. The dummy shift circuit scd is so configured that the node qfd is connected to the node qom of the shift circuit scm, and the node CKAd is connected to the first clock line CKL1 or the second clock line CKL2. When m is an odd number, the node CKAd is connected to the second clock line CKL2. When m is an even number, the node CKAd is connected to the first clock line CKL1.

FIG. 14 is a timing chart illustrating wave patterns of a vertical synchronizing signal VSYNC, the gate start pulse signal GSP, the first clock signal CK1, the second clock signal CK2, the gate-on pulse signals gi (i=1 through m) and an output of the node qod. In the first clock signal CK1 and the second clock signal CK2, a “H (High)” (active) period in one cycle is one clock period, and a “L (Low)” (inactive) period in one cycle is one clock period. The first clock signal CK1 and the second clock signal CK2 are so configured that when one of the CK1 and the CK2 is activated (rises), the other one of the CK1 and the CK2 is inactivated (falls) in a synchronous manner.

In the shift circuit sc1, which is a first-stage shift circuit, when the gate start pulse signal GSP is activated, the node qf1 increases in electric potential so that the first clock signal CK1 is supplied to the node qo1, thereby activating a gate-on pulse signal g1. Further, in the shift circuit sc2, which is a second-stage shift circuit, when the gate-on pulse signal g1 is activated, the node qf2 increases in electric potential so that the second clock signal CK2 is supplied to the node qo2, thereby activating a gate-on pulse signal g2. At this time, in the shift circuit sc1, the activation of the gate-on pulse signal g2 causes the first clock signal CK1 not to be supplied to the node qo1 and causes low-potential side power supply potential to be supplied to the node qo1. As such, the gate-on pulse signal g1 is activated for a certain period and then inactivated, thereby forming a pulse P1.

Similarly, in the shift circuit sci (i=2, 3, . . . , m−1), when a gate-on pulse signal g(i−1) is activated, the node qfi increases in electric potential so that the clock signal (CK1 or CK2) is supplied to the node qoi, thereby activating a gate-on pulse signal gi. Further, in the following-stage shift circuit sc(i+1), the activation of the gate-on pulse signal gi causes an increase in electric potential of the node qf(i+1) so that the clock signal (CK2 or CK1) is supplied to the node qo(i+1), thereby activating a gate-on pulse signal g(i+1). At this time, in the shift circuit sci, the activation of the gate-on pulse signal g(i+1) causes the clock signal not to be supplied to the node qoi and causes low-potential side power supply potential to be supplied to the node qoi. In this way, the gate-on pulse signal gi is activated for a certain period and then inactivated, thereby forming a pulse Pi.

Further, in the shift circuit scm, when a gate-on pulse signal g(m−1) is activated, the node qfm increases in electric potential so that the clock signal (CK1 or CK2) is supplied to the node qom, thereby activating a gate-on pulse signal gm. In the following-stage dummy shift circuit scd, when the gate-on pulse signal gm is activated, the node qfd increases in electric potential so that the clock signal (CK2 or CK1) is supplied to the node qod (the node qod increases in electric potential). At this time, in the shift circuit scm, the increase in electric potential of the node qod causes the clock signal not to be supplied to the node qom and causes low-potential side power supply potential to be supplied to the node qom. As such, the gate-on pulse signal gm is activated for a certain period and then inactivated, thereby forming a pulse Pm.

In this way, the shift register 100 is so configured that respective gate-on pulse signals of the shift circuits are activated sequentially in order for a certain period so that respective pulses are sequentially outputted in the order from the first-stage shift circuit sc1 to the final-stage shift circuit scm. As officially known documents related to such a technique, there are Patent Literatures 1 through 4 described below.

### CITATION LIST

Patent Literature 1

Japanese Patent Application Publication, Tokukai, No. 2001-273785 (Publication Date: Oct. 5, 2001)

Patent Literature 2

Japanese Patent Application Publication, Tokukai, No. 2006-24350 (Publication Date: Jan. 26, 2006)

Patent Literature 3

Japanese Patent Application Publication, Tokukai, No. 2007-114771 (Publication Date: May 10, 2007)

Patent Literature 4

Japanese Patent Application Publication, Tokukai, No. 2006-276409 (Publication Date: Oct. 12, 2006)

### SUMMARY OF INVENTION

However, inventors of the present invention found that when the first and second clock signals CK1 and CK2 rise (are activated) steeply as illustrated in FIG. 14, there easily occurs a poor gate-on pulse signal (which causes turbulence of a wave pattern during inactivation of the gate-on pulse signal, for example). Such a poor gate-on pulse signal is caused due to noise (ringing), which occurs in a shift circuit when a clock signal rises or falls.

An object of the present invention is to provide a display panel drive circuit and a display panel driving method each of which hardly causes a poor gate-on pulse signal (which causes unevenness in electric potential during inactivation of the gate-on pulse signal, for example).

A display panel drive circuit of the present invention is a display panel drive circuit including a shift register including unit circuits connected in cascade, each of the unit circuits outputting a signal line selection signal, and the display panel drive is so configured that: each of the unit circuits receives a clock signal and either a signal line selection signal outputted from another-stage unit circuit or a start pulse signal; and the clock signal has a rising portion caused by activation of the clock signal, the rising portion being sloped, or a falling portion caused by activation of the clock signal, the falling portion being sloped.

In the display panel drive circuit of the present invention, a clock signal to be supplied to the shift register has a sloped rising portion caused by activation of the clock signal or a sloped falling portion caused by activation of the clock signal. This makes it possible to reduce noise (ringing) in a circuit, which occurs at the time of the activation of the clock signal. As a result, it is possible to restrain an occurrence of a poor gate-on pulse signal (which causes unevenness in electric potential during inactivation, for example).

In the display panel drive circuit according to the present invention, the start pulse signal has a rising portion caused by activation of the start pulse signal, the rising portion being sloped, or a falling portion caused by activation of the start pulse signal, the falling portion being sloped.

In the display panel drive circuit according to the present invention, the signal line selection signal has a rising portion caused by activation of the signal line selection signal, the rising portion being sloped, or a falling portion caused by activation of the signal line selection signal, the falling portion being sloped.

The display panel drive circuit according to the present invention may be so configured that a final-stage unit circuit among the unit circuits receives a clear signal, and the clear signal has a rising portion caused by activation of the clear signal, the rising portion being sloped, or a falling portion caused by activation of the clear signal, the falling portion being sloped.

The display panel drive circuit according to the present invention may be so configured that the clock signal has a sloped returned portion following an activation portion thereof.

The display panel drive circuit according to the present invention may be so configured that the start pulse signal has a sloped returned portion following an activation portion thereof.

The display panel drive circuit according to the present invention may be so configured that the signal line selection signal has a sloped returned portion following an activation portion thereof.

The display panel drive circuit according to the present invention may be configured such the clear signal has a sloped returned portion following an activation portion thereof.

The display panel drive circuit according to the present invention may be so configured that each of the unit circuits other than the final-stage unit circuit includes a set transistor, an output transistor, a reset transistor, a potential supply transistor, and a capacitor, and the each of the unit circuits other than the final-stage unit circuit is so configured that: either the start pulse signal or a previous-stage signal line selection signal is supplied to a control terminal of the set transistor; a next-stage signal line selection signal is supplied to a control terminal of the reset transistor; the clock signal is supplied to a first electrically-conducting terminal of the output transistor; a clock signal different from the clock signal is supplied to a control terminal of the potential supply transistor; the output transistor includes a second electrically-conducting terminal that is connected to a first electrode of the capacitor; the set transistor includes a first electrically-conducting terminal that is connected to the control terminal of the set transistor, and a second electrically-conducting terminal that is connected to a control terminal of the output transistor and to a second electrode of the capacitor; the reset transistor includes a first electrically-conducting terminal that is connected to the control terminal of the output transistor, and a second electrically-conducting terminal that is connected to a constant potential source; the potential supply transistor includes a first electrically-conducting terminal that is connected to the second electrically-conducting terminal of the output transistor, and a second electrically-conducting terminal that is connected to a constant potential source; and the second electrically-conducting terminal of the output transistor serves as an output terminal. In the present invention, one of a source terminal and a drain terminal of each of the transistors is referred to as a first electrically-conducting terminal, and the other one is referred to as a second electrically-conducting terminal. However, the configuration of the transistors may be changed depending on designs of the transistors. That is, the first electrically-conducting terminals of all the transistors may serve as drain terminals; the first electrically-conducting terminals of all the transistors may serve as source terminals; or alternatively the first electrically-conducting terminal(s) of any of the transistors may serve as a drain terminal(s), and the first electrically-conducting terminal(s) of the other transistor(s) may serve as a source terminal(s).

The display panel drive circuit according to the present invention may be so configured that the final-stage unit circuit includes a set transistor, an output transistor, a reset transistor, a potential supply transistor, and a capacitor, the final-stage unit circuit is so configured that: a previous-stage signal line selection signal is supplied to a control terminal of the set transistor; the clear signal is supplied to a control terminal of the reset transistor; the clock signal is supplied to a first electrically-conducting terminal of the output transistor; a clock signal different from the one of the clock signals is supplied to a control terminal of the potential supply transistor; the output transistor includes a second electrically-conducting terminal that is connected to a first electrode of the capacitor; the set transistor includes a first electrically-conducting terminal that is connected to the control terminal of the set transistor, and a second electrically-conducting terminal that is connected to a control terminal of the output transistor and to a second electrode of the capacitor; the reset transistor includes a first electrically-conducting terminal that is connected to the control terminal of the output transistor, and a second electrically-conducting terminal that is connected to a constant potential source; the potential supply transistor includes a first electrically-conducting terminal that is connected to the second electrically-conducting terminal, and a second electrically-conducting terminal that is connected to a constant potential source; and the second electrically-conducting terminal of the output transistor serves as an output terminal.

The display panel drive circuit according to the present invention may be so configured that the shift register receives at least two clock signals having different phases, and one of two clock signals among the at least two clock signals is supplied to the unit circuits in odd-numbered stages among the unit circuits, and the other one of the two clock signals among the at least two clock signals is supplied to the unit circuits in even-numbered stages among the unit circuits.

The display panel drive circuit according to the present invention may be so configured that the two clock signals among the at least two clock signals have respective phases that are different from each other by half cycle.

The display panel drive circuit according to the present invention may be so configured that the set transistor, the output transistor, the reset transistor, and the potential supply transistor are N channel transistors. In this case, the first electrically-conducting terminals of these transistors are source terminals, and the second electrically-conducting terminals of the transistors are source terminals. Alternatively, each of the transistors may be so configured that the first electrically-conducting terminal is a source terminal and the second electrically-conducting terminal is a drain terminal.

The display panel drive circuit according to the present invention may further include a timing controller for generating the clock signal and the start pulse signal (and further the clear signal as needed) based on inputted synchronizing signals.

The display panel drive circuit according to the present invention may further include a sloping circuit for sloping the rising portion of the clock signal which rising portion is caused by activation of the clock signal or the falling portion of the clock signal which falling portion is caused by activation of the clock signal.

A liquid crystal display device of the present invention includes the display panel drive circuit; and a liquid crystal panel. In this case, the shift register may be monolithically provided in the liquid crystal panel. Further, the liquid crystal panel may be made from amorphous silicon. Alternatively, the liquid crystal panel may be made from polycrystalline silicon.

A display panel driving method according to the present invention is a method for driving a display panel including a shift register including unit circuits connected in cascade, each of the unit circuits outputting a signal line selection signal, and the method includes the steps of: supplying, to each of the unit circuits, a clock signal and either a signal line selection signal outputted from another-stage unit circuit or a start pulse signal; and sloping a rising portion or a falling portion of the clock signal, the rising portion or the falling portion being caused by activation of the clock signal.

With the configuration of the display panel drive circuit of the present invention, it is possible to reduce noise (ringing) in a circuit, which occurs at the time of activation of a clock signal. Consequently, this can restrain a poor gate-on pulse signal (which causes unevenness in electric potential during inactivation of the gate-on pulse signal, for example).

### BRIEF DESCRIPTION OF DRAWINGS

FIG. 1 is a timing chart illustrating how a shift register of the present invention operates.

FIG. 2 is a block diagram illustrating a configuration of a shift register of the present invention.

FIG. 3(a) and (b) are circuit diagrams each illustrating a configuration of a circuit (unit circuit) in each stage of a shift register.

FIG. 4 is a circuit diagram illustrating a configuration of a shift register of the present invention.

FIG. 5 is a circuit diagram illustrating another configuration of a shift register of the present invention.

FIG. 6(a) and (b) are circuit diagrams each illustrating a configuration of a unit circuit of the shift register in FIG. 5.

FIG. 7 is a timing chart illustrating how the shift register in FIG. 5 operates.

FIG. 8 is a block diagram illustrating a configuration of a liquid crystal display device of the present invention.

FIG. 9(a) and (b) are circuit diagrams each illustrating a configuration of a sloping circuit.

FIG. 10 is a block diagram illustrating a block diagram illustrating another configuration of a display panel drive circuit of the present invention.

FIG. 11(a) through (c) are views each illustrating wave patterns of clock signals supplied to a shift register of a display panel drive circuit of the present invention.

FIG. 12(a) and (b) are views each illustrating wave patterns of clock signals supplied to a shift register of a display panel drive circuit of the present invention.

FIG. 13 is a block diagram illustrating a configuration of a conventional shift register.

FIG. 14 is a timing chart illustrating how the shift register in FIG. 13 operates.

### REFERENCE SIGNS LIST

1 Liquid Crystal Display Device (Display Device)
3 Liquid Crystal Panel
10a Shift Register
10f Shift Register
10g Shift Register
11 Display Panel Drive Circuit
13 Sloping Circuit
GSP Gate Start Pulse Signal
G1 through Gm Gate-on Pulse (Signal Line Selection Signal)
SC1 through SCm Shift Circuit (Unit Circuit)
CK1 First Clock Signal
CK2 Second Clock Signal
CK3 Third Clock Signal
CK4 Fourth Clock Signal
CLR Clear Signal
Tra Set Transistor
Trb Output Transistor
Trd Reset Transistor
Tre through Trg Potential Supply Transistor
α Rising Portion Caused by Activation
β Returned Portion

### DESCRIPTION OF EMBODIMENTS

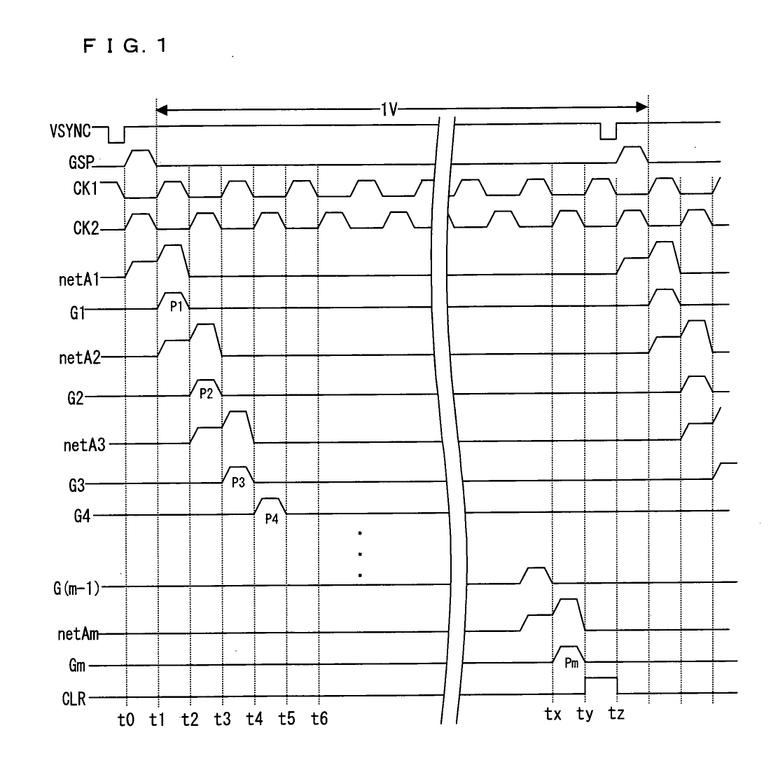

One embodiment of the present invention is described below with reference to FIG. 1 through FIG. 12.

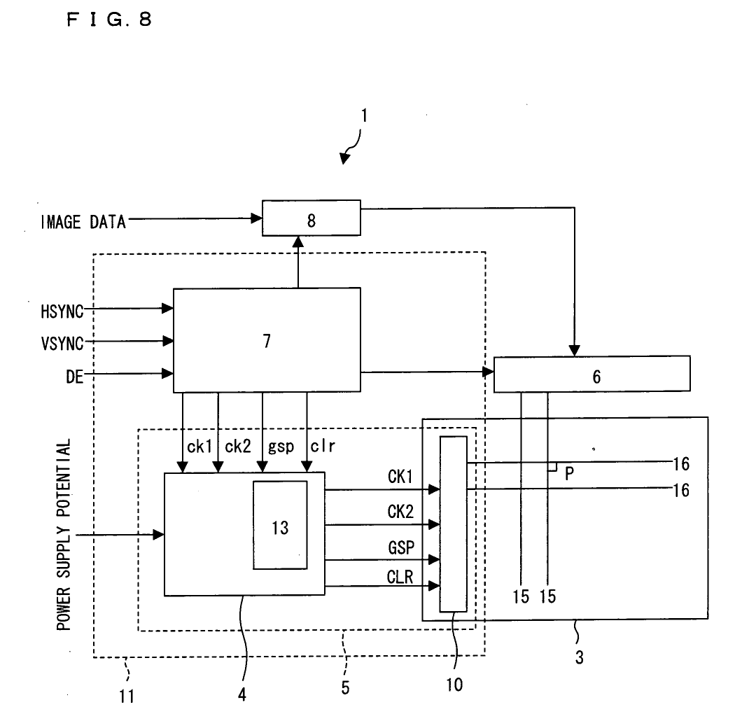

FIG. 8 is a block diagram illustrating a configuration of a liquid crystal display device according to the present embodiment. As illustrated in FIG. 8, the liquid crystal display device 1 includes a liquid crystal panel 3, a gate driver 5, a source driver 6, a timing controller 7, and a data processing circuit 8. The gate driver 5 is provided with a shift register 10 and a level shifter 4 including a sloping circuit 13. The gate driver 5 and the timing controller 7 constitute a liquid crystal panel drive circuit 11.

The liquid crystal panel 3 is provided with scanning signal lines 16 driven by the gate driver 5, data signal lines 15 driven by the source driver 6, pixels P, retention capacitor wiring lines (not shown) and the like. Further, in the liquid crystal panel 3 is provided the shift register 10 monolithically. In each of the pixels P are provided a transistor (TFT) and a pixel electrode. The transistor (TFT) is connected to a corresponding scanning signal line 16 and a corresponding data signal line 15, and the pixel electrode is connected to the transistor. The transistor in each of the pixels and a transistor provided in the shift register are made from amorphous silicon, polycrystalline silicon (for example, CG silicon) or the like.

Into the timing controller 7 are supplied a vertical synchronizing signal VSYNC, a horizontal synchronizing signal HSYNC, and a data enable signal DE from an outside of the liquid crystal display device 1. These signals are synchronizing signals. Further, into the data processing circuit 8 are supplied video data (RGB digital data) from an outside of the liquid crystal display device 1. The timing controller 7 generates, based on the synchronizing signals, a plurality of source clock signals (ck1, ck2 and the like), a source clear signal (clr), and a source gate start pulse signal (gsp). The source clock signals (ck1, ck2 and the like) and the source gate start pulse signal (gsp) are processed by the level shifter 4 so that (i) these signals are level shifted and (ii) a rising portion, of each of the signals, that is caused by activation, and a returned portion of the each of the signals are both sloped. As a result, the source clock signals (ck1, ck2 and the like) and the source gate start pulse signal (gsp) become clock signals (CK1, CK2 and the like) and a gate start pulse signal (GSP), respectively. The source clear signal (clr) is also level shifted by the level shifter 4 so as to become a clear signal (CLR). The level shifter 4 may perform level shifting on the source clear signal (clr) and process the source clear signal (clr) so that a rising portion, of the source clear signal (clr), that occurs at the time of activation and a returned portion of the source clear signal (clr) are sloped. Further, the timing controller 7 outputs, based on the received synchronizing signals (VSYNC, HSYNC, and DE), a control signal to the data processing circuit 8 and a source timing signal to the source driver 6.

The clock signals (CK1, CK2 and the like), the clear signal (CLR), and the gate start pulse signal (GSP) are then supplied to the shift register 10. The clear signal (CLR) is a signal for resetting a final-stage shift circuit in the shift register. The shift register 10 generates gate-on pulse signals from these signals (CK1, CK2 and the like; CLR; and GSP) and supplies the gate-on pulse signals to the respective scanning signal lines in the liquid crystal panel 3. The shift register 10 is constituted by shift circuits each for supplying a gate-on pulse signal such that the shift circuits are connected in cascade so that respective gate-on pulse signals of the shift circuits are activated sequentially in order for a certain period of time, thereby causing respective pulses (on-pulses) to be outputted sequentially in the order from the first-stage shift circuit to the final-stage shift circuit. In the liquid crystal panel 3, the scanning signal lines are accordingly selected in turn by the respective pulses thus outputted.

The data processing circuit 8 performs a predetermined process on the video data and supplies a data signal to the source driver 6 based on the control signal from the timing controller 7. The source driver 6 generates signal potential from the data signal received from the data processing circuit 8 and the source timing signal received from the timing controller 7. The source driver 6 then supplies the signal potential to the data signal lines in the liquid crystal panel 3. The signal potential is written in a pixel electrode of each of the pixels via a transistor of the each of the pixels.

### Embodiment 1

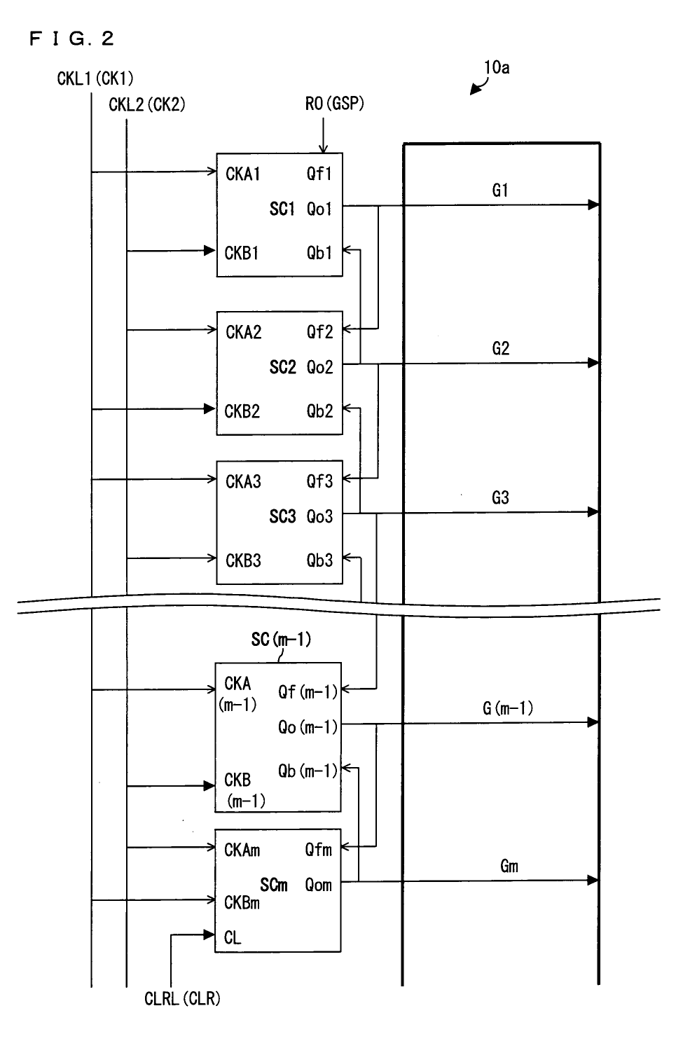

FIG. 2 illustrates a configuration of a shift register 10a according to Embodiment 1. As illustrated in FIG. 2, the shift register 10a includes a plurality of shift circuits (unit circuits) SC1, SC2, . . . SCm that are connected in cascade. Each shift circuit SCi (i=1, 2, 3, . . . , m−1) includes input nodes Qfi, Qbi, CKAi and CKBi, and an output node Qoi. In the meantime, the shift circuit SCm includes input nodes Qfm, CKAm, CKBm and CL, and an output node Qom.

Here, the shift circuit SC1 is so configured that: a node Qf1 is connected to a GSP output end RO of a level shifter (see FIG. 8); a node Qb1 is connected to a node Qo2 of the shift circuit SC2; a node CKA1 is connected to a first clock line CKL1 from which a first clock signal CK1 is supplied; a node CKB1 is connected to a second clock line CKL2 from which a second clock signal CK2 is supplied; and a node Qo1 outputs a gate-on pulse signal (signal line selection signal) G1.

Further, the other shift circuit SCi (i=2 through m−1) is so configured that: the node Qfi is connected to a node Qo(i−1) of a shift circuit SC(i−1); the node Qbi is connected to a node Qo(i+1) of a shift circuit SC(i+1); the node CKAi is connected to the first clock line CKL1 and the node CKBi is connected to the second clock line CKL2 when i is an odd number, while the node CKAi is connected to the second clock line CKL2 and the node CKBi is connected to the first clock line CKL1 when i is an even number; and the node Qoi outputs a gate-on pulse signal (signal line selection signal) G1.

The shift circuit SCm is so configured that: the node Qfm is connected to a node Qo(m−1) of a shift circuit SC(m−1); the node CKAm is connected to the second clock line CKL2 and the node CKBm is connected to the first clock line CKL1; the node CL is connected to a clear line CLRL; and the node Qom outputs a gate-on pulse signal (signal line selection signal) Gm.

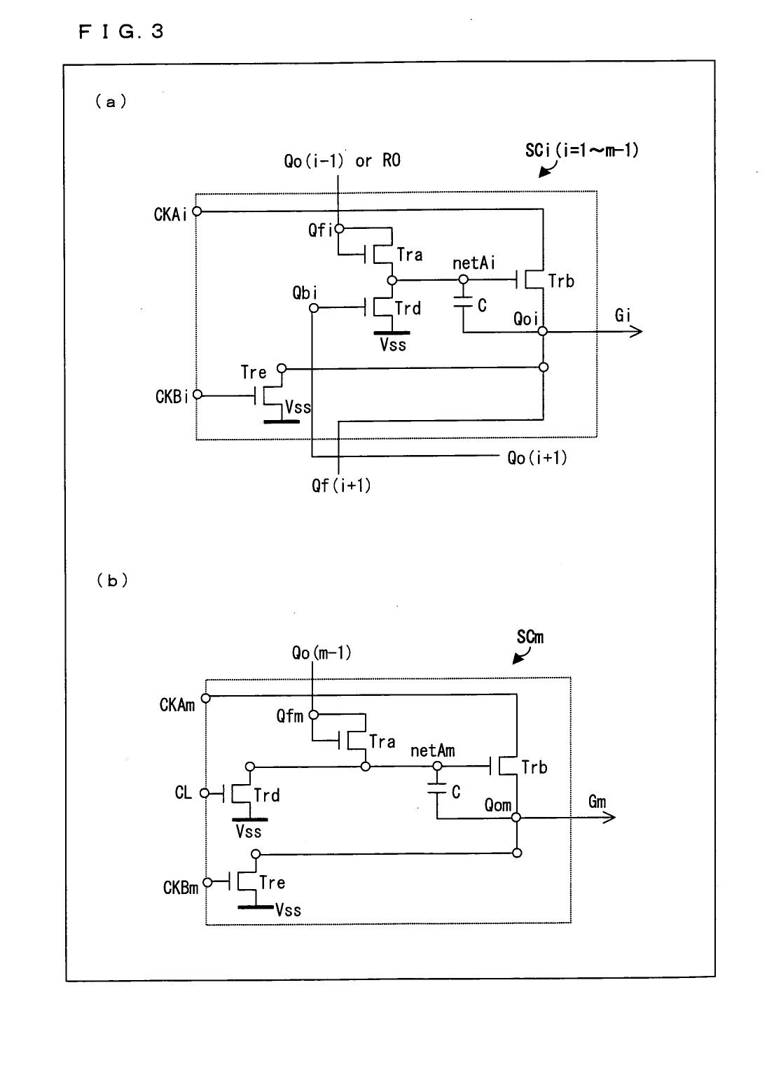

(a) of FIG. 3 is a circuit diagram specifically illustrating a configuration of the SCi (i=1 through m−1). As illustrated in (a) of FIG. 3, the SCi (i=1 through m−1) includes a set transistor Tra, an output transistor Trb, a reset transistor Trd, a potential supply transistor Tre, and a capacitor C. The transistors Tra, Trb, Trd and Tre are N channel transistors, and the capacitor C may be a parasitic capacitor.

More specifically, a source terminal of the Trb is connected to a first electrode of the capacitor C, a gate terminal (control terminal) of the Tra is connected to a drain terminal of the Tra, and a source terminal of the Tra is connected to a gate terminal of the Trb and to a second electrode of the capacitor C. Further, a drain terminal of the Trd is connected to the gate terminal of the Trb and a source terminal of the Trd is connected to a low-potential side power supply Vss. Moreover, a drain terminal of the Tre is connected to the source terminal of the Trb, and a source terminal of the Tre is connected to a low-potential side power supply Vss. The control terminal of the Tra is connected to the node Qfi, a drain terminal of the Trb is connected to the node CKAi, a gate terminal of the Tre is connected to the node CKBi, a gate terminal of the Trd is connected to the node Qbi, and the source terminal of the Trb is connected to the node Qoi. A connection point at which the source terminal of the Tra, the second electrode of the capacitor C and the gate terminal of the Trb are connected to each other is referred to as a node netAi.

Further, (b) of FIG. 3 is a circuit diagram specifically illustrating a configuration of the SCm. As illustrated in (b) of FIG. 3, the SCm includes a set transistor Tra, an output transistor Trb, a reset transistor Trd, a potential supply transistor Tre, and a capacitor C. The transistors Tra, Trb, Trd and Tre are N channel transistors, and the capacitor C may be a parasitic capacitor.

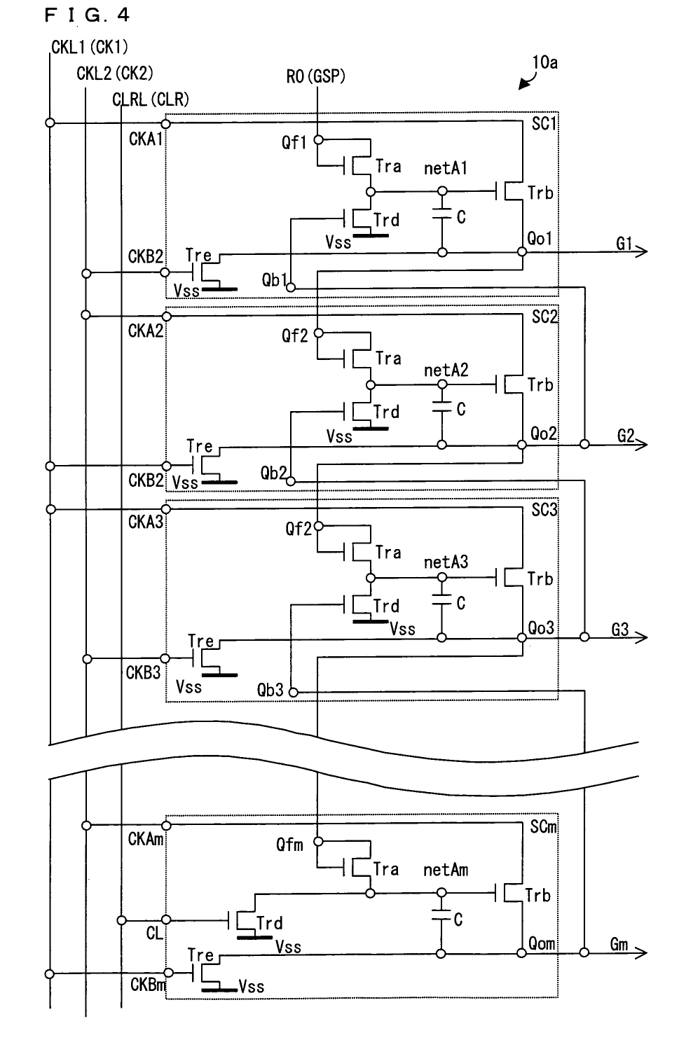

More specifically, a source terminal of the Trb is connected to a first electrode of the capacitor C, a gate terminal (control terminal) of the Tra is connected to a drain terminal of the Tra, and a source terminal of the Tra is connected to a gate terminal of the Trb and to a second electrode of the capacitor C. Further, a drain terminal of the Trd is connected to the gate terminal of the Trb, and a source terminal of the Trd is connected to a low-potential side power supply Vss. Moreover, a drain terminal of the Tre is connected to a source terminal of the Trb, and a source terminal of the Tre is connected to a low-potential side power supply Vss. The control terminal of the Tra is connected to the node Qfm, a drain terminal of the Trb is connected to the node CKAm, a gate terminal of the Trd is connected to the node CL, a gate terminal of the Tre is connected to the node CKBm, and the source terminal of the Trb is connected to the node Qom. A connection point at which the source terminal of the Tra, the second electrode of the capacitor C and the gate terminal of the Trb are connected to each other is referred to as a node netAm.

Where each of the nodes (Qfi, Qbi, CKAi, CKBi, Qoi) of the shift circuit SCi (i=1 through m−1) is connected to and where each of the nodes (Qfm, CKAm, CKBm, CL, Qom) of the shift circuit SCm is connected to are as illustrated in FIG. 2. A specific configuration of the entire shift register 10a is as illustrated in FIG. 4.

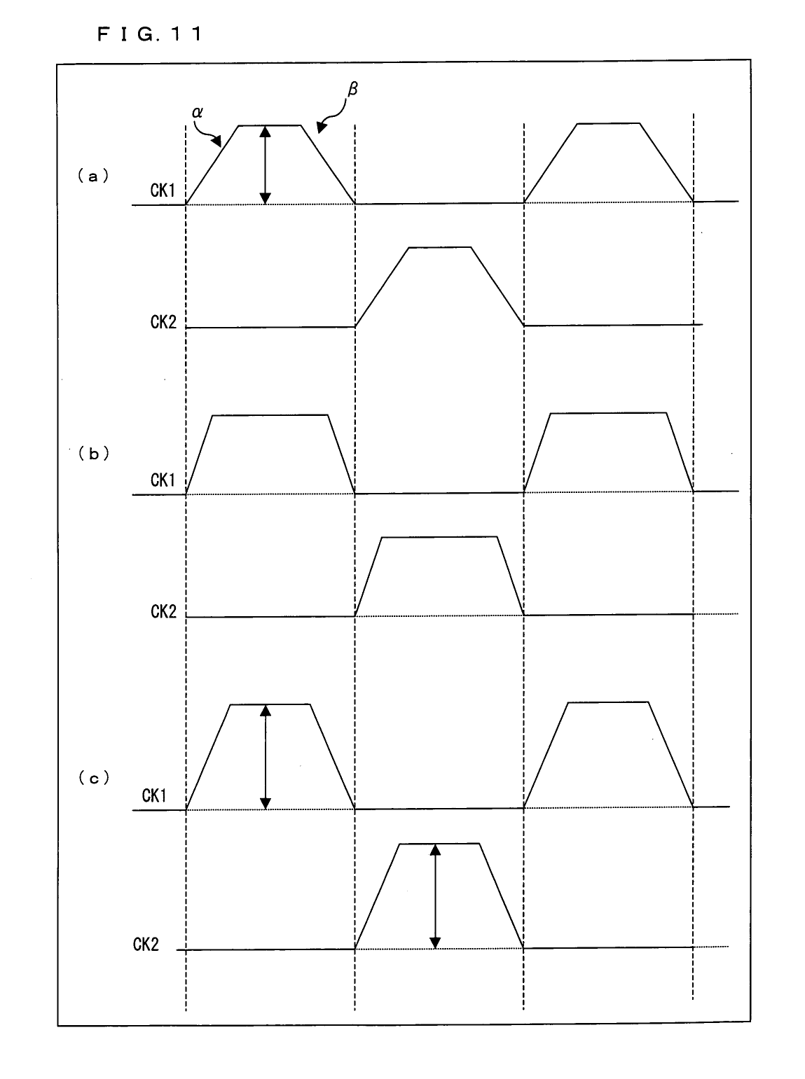

The following describes how the shift register 10a operates. FIG. 1 is a timing chart illustrating wave patterns of the vertical synchronizing signal VSYNC, the gate start pulse signal GSP, the first clock signal CK1, the second clock signal CK2, the gate-on pulse signal Gi (i=1 through m) and the clear signal (CLR) in a case where the synchronizing signals are normal. In the first clock signal CK1 and the second clock signal CK2, a “H” (active) period in one cycle is one clock period, and a “L” (inactive) period in one cycle is one clock period. The first clock signal CK1 and the second clock signal CK2 are so configured that when one of the CK1 and the CK2 falls, the other one of the CK1 and the CK2 rises in a synchronous manner. As illustrated (a) of FIG. 11, in each of the CK1 and the CK2, a rising portion a thereof caused by activation thereof and a returned portion 13 thereof are both sloped.

Initially, at t0 in FIG. 1, the GSP moderately rises (becomes active) and causes the Qf1 to increase in electric potential, thereby causing the Tra of the SC1 to be turned on so that electric potential of the netA1 increases from “L” to “H”. The Trb of the SC1 is accordingly turned on so that the CK1 is supplied to the Qo1.

At t1, which is one clock period after t0, the GSP moderately falls (becomes inactive) to “L”. However, the electric potential of the netA1 does not decrease due to the capacitor C of the SC1, and therefore the Trb of the SC1 is kept on. Consequently, when the CK1 moderately rises, G1 is also activated so that the G1 increases to “H”. At this time, the electric potential of the netA1 is set up higher than “H” by the capacitor C. This allows the G1 to have sufficient amplitude (electric potential). On the other hand, the activation of the G1 increases electric potential of the Qf2, thereby causing the Tra of the SC2 to be turned on so that electric potential of the netA2 increases from “L” to “H”. The Trb of the SC2 is accordingly turned on so that the CK2 is supplied to the Qo2. That is, G2 remains “L” at this moment.

At t2, which is one clock period after t1, the CK2 moderately rises so that the G2 becomes active and increases to “H”. At this time, electric potential of the netA2 is set up higher than “H” by the capacitor C. This allows the G2 to have sufficient amplitude (electric potential). On the other hand, the activation of the G2 increases electric potential of the Qb1, thereby causing the Trd of the SC1 to be turned on so that the netA1 is connected to the Vss and the electric potential of the netA1 accordingly decreases from “H” to “L”. As a result, the Trb of the SC1 is turned off, thereby causing the supply of the CK1 to the Qo1 to be stopped. Further, since the CK2 moderately rises at t2, the Tre of the SC1 is turned on so that the Qo1 is connected to the Vss and the electric potential of the Qo1 decreases from “H” to “L”. As a result, the G1 decreases from “H” to “L” and becomes inactive. The inactivation of the G1 is maintained. Even after the G1 is inactivated and decreases to “L”, the electric potential of the netA2 is maintained by the capacitor C of the SC2 and therefore the Trb of the SC2 is kept on. Further, the activation of the G2 increases electric potential of the Qf3, thereby causing the Tra of the SC3 to be turned on so that electric potential of the netA3 increases from “L” to “H”. The Trb of the SC3 is accordingly turned on so that the CK1 is supplied to the Qo3. That is, G3 remains “L” at this moment.

At t3, which is one clock period after t2, the CK1 moderately rises so that the G3 becomes active and increases to “H”. On the other hand, the activation of the G3 increases electric potential of the Qb2, thereby causing the Trd of the SC2 to be turned on so that the netA2 is connected to the Vss and therefore the electric potential of the netA2 decreases from “H” to “L”. As a result, the Trb of the SC2 is turned off, thereby causing the supply of the CK2 to the Qo2 to be stopped. Further, since the CK1 moderately rises at t3, the Tre of the SC2 is turned on so that the Qo2 is connected to the Vss and the electric potential of the Qo2 decreases from “H” to “L”. As a result, the G2 decreases from “H” to “L” and becomes inactive. The inactivation of the G2 is maintained.

In the shift register 10a, for a period from t4 to t5 and a period from t6 to t7, since the CK2 is set “H”, the Tre of the SC1 is turned on so that the Qo1 is connected to the Vss, thereby dropping the G1 to “L” again (i.e., the G1 is drawn back to “L”). Similarly, for a period from t5 to t6, since the CK1 is set “H”, the Tre of the SC2 is turned on so that the Qo2 is connected to the Vss, thereby dropping the G2 to “L” again (i.e., the G2 is drawn back to “L”).

Moreover, at tx, since the CK2 moderately rises, the Gm also becomes active so that the Gm increases to “H”. At this time, electric potential of the netAm is set up higher than “H” by the capacitor C.

At ty, which is one clock period after tx, the clear signal CLR is activated and increases to “H”, thereby causing the Trd of the SCm to be turned on so that the netAm is connected to the Vss and the electric potential of the netAm falls to “L”. The Trb of the SCm is accordingly turned off and therefore the supply of the CK2 to the Qom is stopped. On the other hand, since the CK1 moderately rise at ty, the Tre of the SCm is turned on and the Qom is connected to the Vss. As a result, the Gm is inactivated and decreases to “L”.

In this way, in the shift register 10a, respective gate-on pulse signals Gi of the shift circuits SCi (i=1 through m) are activated sequentially in order for a certain period so that respective pulses are outputted sequentially in the order from the first-stage shift circuit SC1 to the final-stage shift circuit SCm.

In the shift circuit SCi (i=1 through m), in a case where the CK1/CK2 steeply rises (i.e., the rising portions thereof caused by activation are steep) and the CK1/CK2 steeply falls (i.e., the returned portions thereof are steep), there may arise such problems that even if the gate terminal of the transistor Trb is set to “L”, current flows between the source and drain terminals of the transistor Trb and that the electric potential of the node Qoi fluctuates due to ON/OFF of the transistor Tre. This may cause the electric potential of the gate-on pulse signal Gi to become uneven or the like at the time when the gate-on pulse signal Gi is inactive. However, in the shift register 10a of the present embodiment, the CK1/CK2 moderately rises (i.e., the rising portions thereof caused by activation are moderate) and the CK1/CK2 moderately falls (i.e., the returned portions thereof are moderate) so that the above problems can be prevented and a poor gate-on pulse signal hardly occurs.

A shift register generally causes such a problem that in a latter-stage shift circuit (along a shift direction), its gate-on pulse signal Gi exhibits a rather monotonous wave pattern or its active electric potential relatively decreases. In view of this, as illustrated in FIG. 10, the shift register may be so configured that a first half of stages in the shift register receives a first clock signal CK1(x) and a second clock signal CK2(x) and a second half of stages in the shift register receives a first clock signal CK1(y), and a second clock signal CK2(y). At this time, the CK1(x) and the CK2(x) have respective wave patterns as illustrated in (a) of FIG. 11 and the CK1(y) and the CK2(y) have respective wave patterns as illustrated in (b) of FIG. 11. As illustrated in (a) and (b) of FIG. 11, gradients of slopes of the clock signals CK1 and CK2 can be made different between the first half and the second halves of stages (phases are the same). In this case, the gradients of the slopes of the clock signals that are supplied to the second half of stages are set smaller than those of the clock signals that are supplied to the first half of stages. Further, such a configuration may be also possible that the CK1(x) and the CK2(x) exhibit the respective wave patterns illustrated in (a) of FIG. 11 and the CK1(y) and the CK2(y) exhibit respective wave patterns illustrated in (c) of FIG. 11, so that the first half and the second halves of stages have pulses different in height (phases are the same). In this case, the pulses of the clock signals supplied to the second half of stages are set higher in height than the pulses of the clock signals supplied to the first half of stages.

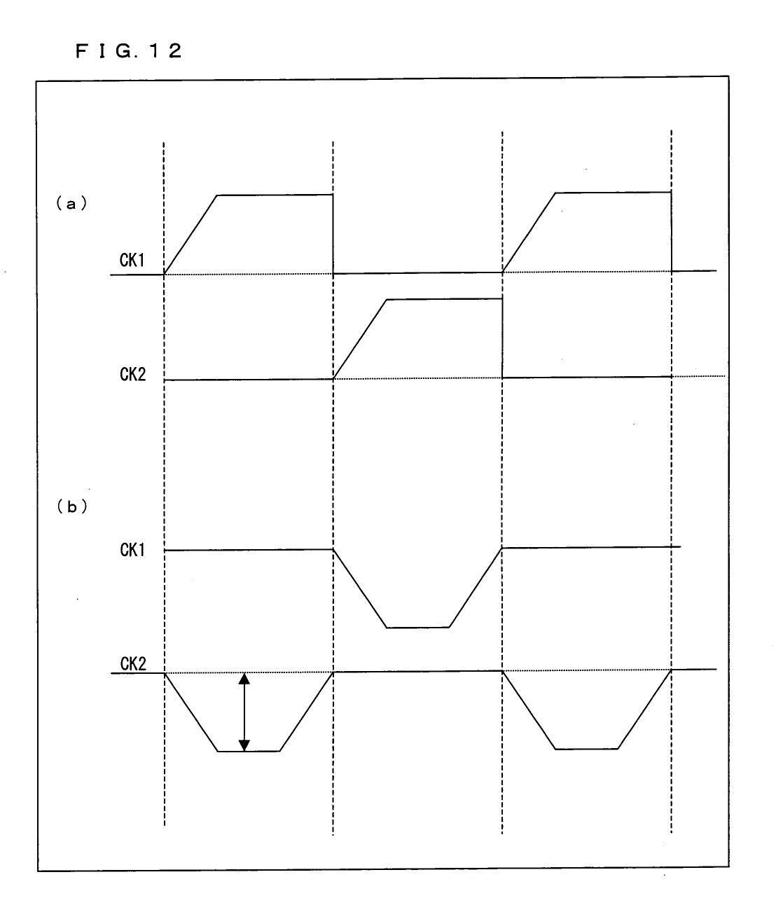

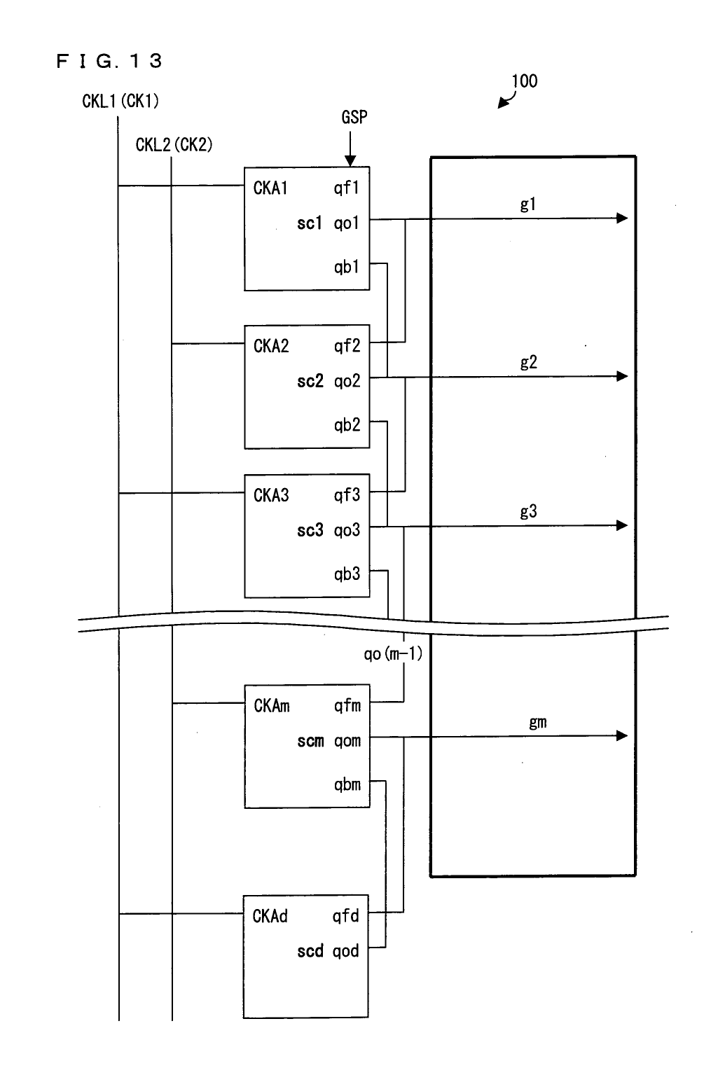

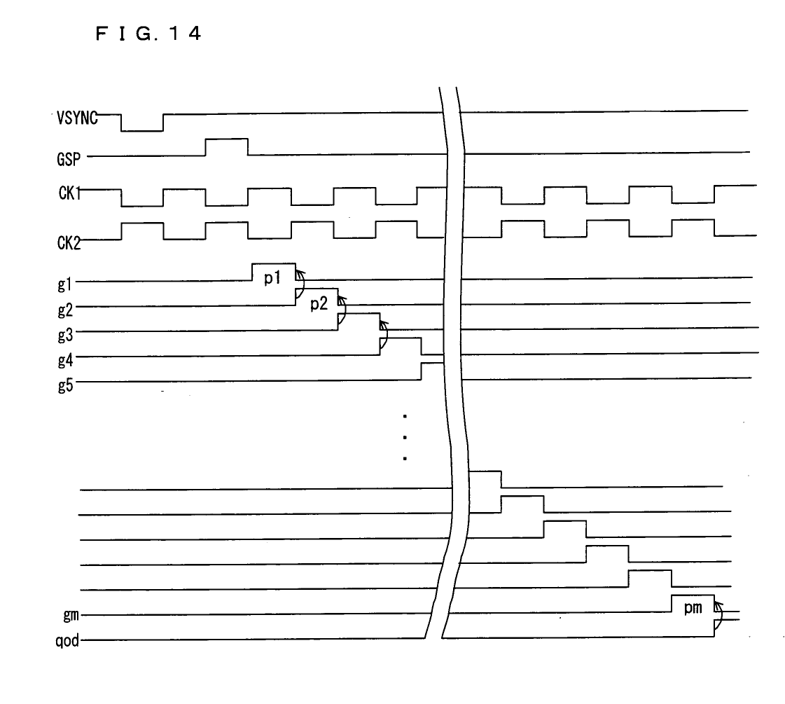

Moreover, in the present embodiment, a signal that can be used as the clock signals may be such that only its rising portion caused by activation of the signal is sloped and its returned portion (falling portion) is not sloped, as illustrated in (a) of FIG. 12. Further, depending on the polarity of transistors of the shift register, such a signal may be also used that its falling portion caused by activation of the signal and its returned portion (rising portion) are both sloped, as illustrated in (b) of FIG. 12.

### Embodiment 2

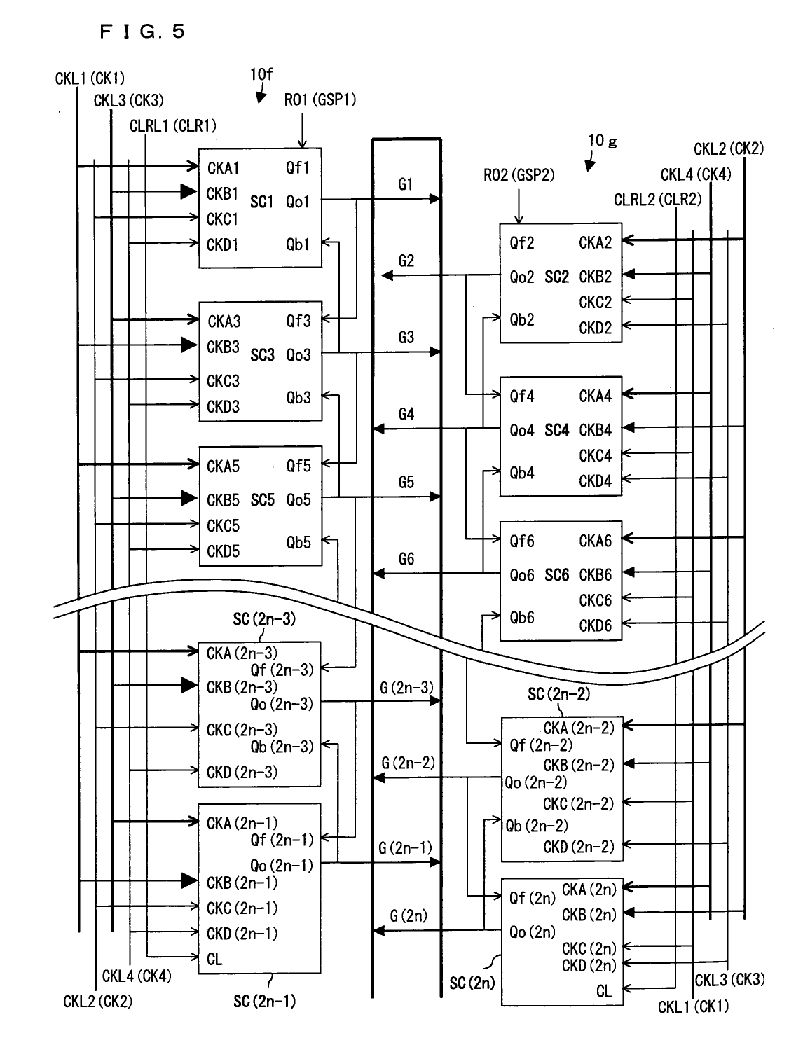

A configuration of a liquid crystal panel according to Embodiment 2 is illustrated in FIG. 5. As illustrated in FIG. 5, the liquid crystal panel includes a shift register 10f on its left side and a shift register 10g on its right side. The shift register 10f includes a plurality of shift circuits SCi (i=1, 3, 5, . . . , 2n+1) that are connected in cascade. The shift register 10g includes a plurality of shift circuits SCi (i=2, 4, 6, . . . , 2n) that are connected in cascade. The shift circuit SCi (i=1, 2, 3, . . . , 2n−2) includes input nodes Qfi, Qbi, CKAi, CKBi, CKCi and CKDi, and an output node Qoi. The shift circuit SC(2n−1) includes input nodes Qf(2n−1), CKA(2n−1), CKB(2n−1), CKC(2n−1), CKD(2n−1) and CL, and an output node Qo(2n−1). Further, the shift circuit SC(2n) includes input nodes Qf(2n), CKA(2n), CKB(2n), CKC(2n), CKD(2n) and CL, and an output node Qo(2n).

Here, a shift circuit SC1 is so configured that: a node Qf1 is connected to an output end RO1 of a GSP1 of a level shifter (see FIG. 8); a node Qb1 is connected to a node Qo3 of a shift circuit SC3; a node CKA1 is connected to a first clock line CKL1 from which a first clock signal is supplied; a node CKB1 is connected to a third clock line CKL3 from which a third clock signal is supplied; a node CKC1 is connected to a second clock line CKL2 from which a second clock signal is supplied; a node CKD1 is connected to a fourth clock line CKL4 from which a fourth clock signal is supplied; and a node Qo1 outputs a gate-on pulse signal (signal line selection signal) G1.

Further, a shift circuit SC2 is so configured that: a node Qf2 is connected to an output end RO2 of a GSP2 of a level shifter; a node Qb2 is connected to a node Qo4 of a shift circuit SC4; a node CKA2 is connected to the second clock line CKL2 from which the second clock signal is supplied; a node CKB2 is connected to the fourth clock line CKL4 from which the fourth clock signal is supplied; a node CKC2 is connected to the first clock line CKL1 from which the first clock signal is supplied; a node CKD2 is connected to the third clock line CKL3 from which the third clock signal is supplied; and a node Qo2 outputs a gate-on pulse signal (signal line selection signal) G2.

Further, the other shift circuit SCi (i=3 through 2n−2) is configured as described below. That is, the node Qfi is connected to a node Qo(i−2) of a shift circuit SC(i−2), and a node Qbi is connected to a node Qo(i+2) of a shift circuit SC(i+2). Moreover, (i) when i is a multiple of 4 plus 1, the node CKAi is connected to the first clock line CKL1, the node CKBi is connected to the third clock line CKL3, the node CKCi is connected to the second clock line CKL2, and the node CKDi is connected to the fourth clock line CKL4; (ii) when i is a multiple of 4 plus 2, the node CKAi is connected to the second clock line CKL2, the node CKBi is connected to the fourth clock line CKL4, the node CKCi is connected to the first clock line CKL1, and the node CKDi is connected to the third clock line CKL3; (iii) when i is a multiple of 4 plus 3, the node CKAi is connected to the third clock line CKL3, the node CKBi is connected to the first clock line CKL1, the node CKCi is connected to the second clock line CKL2, and the node CKDi is connected to the fourth clock line CKL4; and (iv) when i is a multiple of 4, the node CKAi is connected to the fourth clock line CKL4, the node CKBi is connected to the second clock line CKL2, the node CKCi is connected to the first clock line CKL1, and the node CKDi is connected to the third clock line CKL3. Further, the node Qoi outputs a gate-on pulse signal (signal line selection signal) Gi.

The shift circuit SC(2n−1) is so configured that: the node Qf(2n−1) is connected to a node Qo(2n−3) of a shift circuit SC(2n−3); the node CKA(2n−1) is connected to the third clock line CKL3; the node CKB(2n−1) is connected to the first clock line CKL1; the node CKC(2n−1) is connected to the second clock line CKL2; the node CKD(2n−1) is connected to the fourth clock line CKL4; the node CL is connected to a first clear line CLRL1; and the node Qo(2n−1) outputs a gate-on pulse signal (signal line selection signal) G(2n−1).

The shift circuit SC(2n) is so configured that: the node Qf(2n) is connected to a node Qo(2n−2) of a shift circuit SC(2n−2); the node CKA(2n) is connected to the fourth clock line CKL4; the node CKB(2n) is connected to the second clock line CKL2; the node CKC(2n) is connected to the first clock line CKL1; the node CKD(2n) is connected to the third clock line CKL3; the node CL is connected to a second clear line CLRL2; and the node Qo(2n) outputs a gate-on pulse signal (signal line selection signal) G(2n).

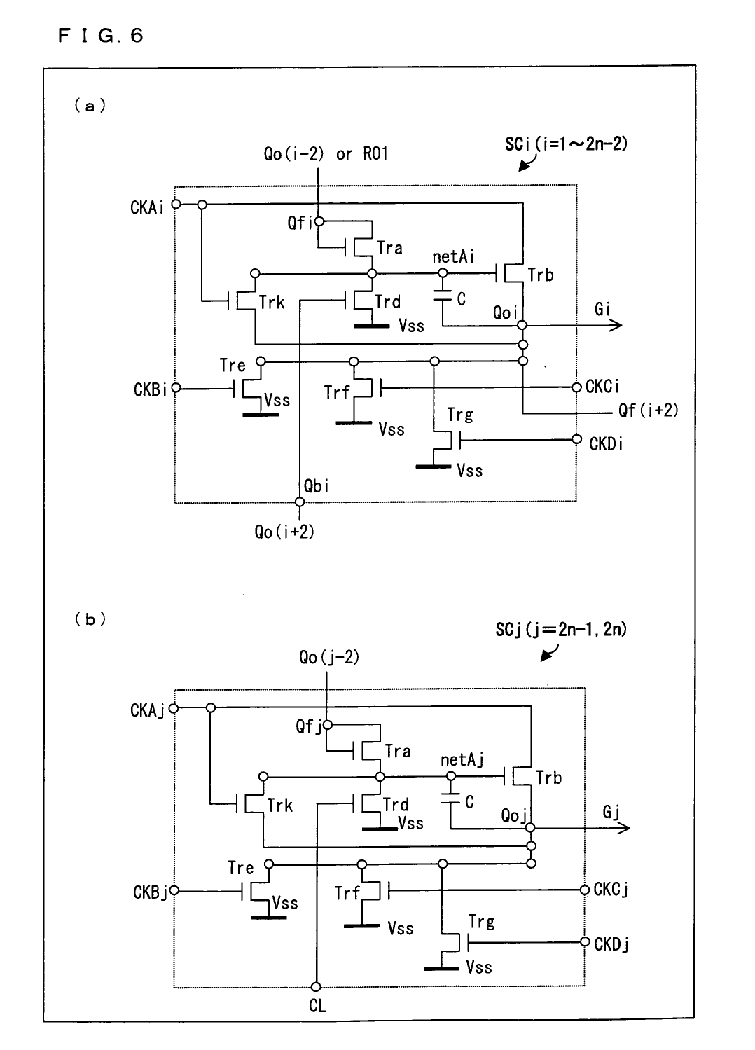

(a) of FIG. 6 is a circuit diagram specifically illustrating a configuration of the SCi (i=1 through 2n−2). As illustrated in (a) of FIG. 6, the SCi (i=1 through 2n−2) includes a set transistor Tra, an output transistor Trb, a reset transistor Trd, potential supply transistors Tre through Trg, a short-circuit transistor Trk, and a capacitor C. The transistors Tra, Trb, Trd through Trg, and Trk are N channel transistors.

More specifically, a source terminal of the Trb is connected to a first electrode of the capacitor C, a gate terminal (control terminal) of the Tra is connected to a drain terminal of the Tra, and a source terminal of the Tra is connected to a gate terminal of the Trb and to a second electrode of the capacitor C. Further, a drain terminal of the Trk is connected to the gate terminal of the Trb, a source terminal of the Trk is connected to the source terminal of the Trb, and a gate terminal of the Trk is connected to a drain terminal of the Trb. Further, a drain terminal of the Trd is connected to the gate terminal of the Trb and a source terminal of the Trd is connected to a low-potential side power supply Vss. Moreover, drain terminals of the Tre through Trg are connected to the source terminal of the Trb, and source terminals of the Tre through Trg are connected to respective low-potential side power supplies Vss. The control terminal of the Tra is connected to the node Qfi, the drain terminal of the Trb is connected to the node CKAi, a gate terminal of the Tre is connected to the node CKBi, a gate terminal of the Trf is connected to the node CKCi, a gate terminal of the Trg is connected to the node CKDi, a gate terminal of the Trd is connected to the node Qbi, and the source terminal of the Trb is connected to the node Qoi. A connection point at which the source terminal of the Tra, the second electrode of the capacitor C, and the gate terminal of the Trb are connected to each other is referred to as a node netAi.

Further, (b) of FIG. 6 is a circuit diagram specifically illustrating a configuration of an SCj (j=(2n−1) or 2n). As illustrated in (b) of FIG. 6, the SCj includes a set transistor Tra, an output transistor Trb, a reset transistor Trd, potential supply transistors Tre through Trg, a short-circuit transistor Trk, and a capacitor C. The transistors Tra, Trb, Trd through Trg, and Trk are N channel transistors.

More specifically, a source terminal of the Trb is connected to a first electrode of the capacitor C, a gate terminal (control terminal) of the Tra is connected to a drain terminal of the Tra, and a source terminal of the Tra is connected to a gate terminal of the Trb and to a second electrode of the capacitor C. Further, a drain terminal of the Trk is connected to the gate terminal of the Trb, a source terminal of the Trk is connected to the source terminal of the Trb, and a gate terminal of the Trk is connected to a drain terminal of the Trb. Further, a drain terminal of the Trd is connected to the gate terminal of the Trb, and a source terminal of the Trd is connected to a low-potential side power supply Vss. Moreover, drain terminals of the Tre through Trg are connected to the source terminal of the Trb, and source terminals of the Tre through Trg are connected to respective low-potential side power supplies Vss. The control terminal of the Tra is connected to a node Qfj, the drain terminal of the Trb is connected to a node CKAj, a gate terminal of the Tre is connected to a node CKBj, a gate terminal of the Trf is connected to a node CKCj, a gate terminal of the Trg is connected to a node CKDj, a gate terminal of the Trd is connected to a node CL, and the source terminal of the Trb is connected to the node Qoj. A connection point at which the source terminal of the Tra, the second electrode of the capacitor C, and the gate terminal of the Trb are connected to each other is referred to as a node netAj.

Where each of the nodes (Qfi, Qbi, CKAi, CKBi, CKCi, CKDi, Qoi) of the shift circuit SCi (i=1 through 2n−2) is connected to and where each of the nodes (Qfj, CKAj, CKBj, CKCj, CKDj, CL, Qoj) of the shift circuit SCj (j=(2n−1) or 2n) is connected to are as illustrated in FIG. 5.

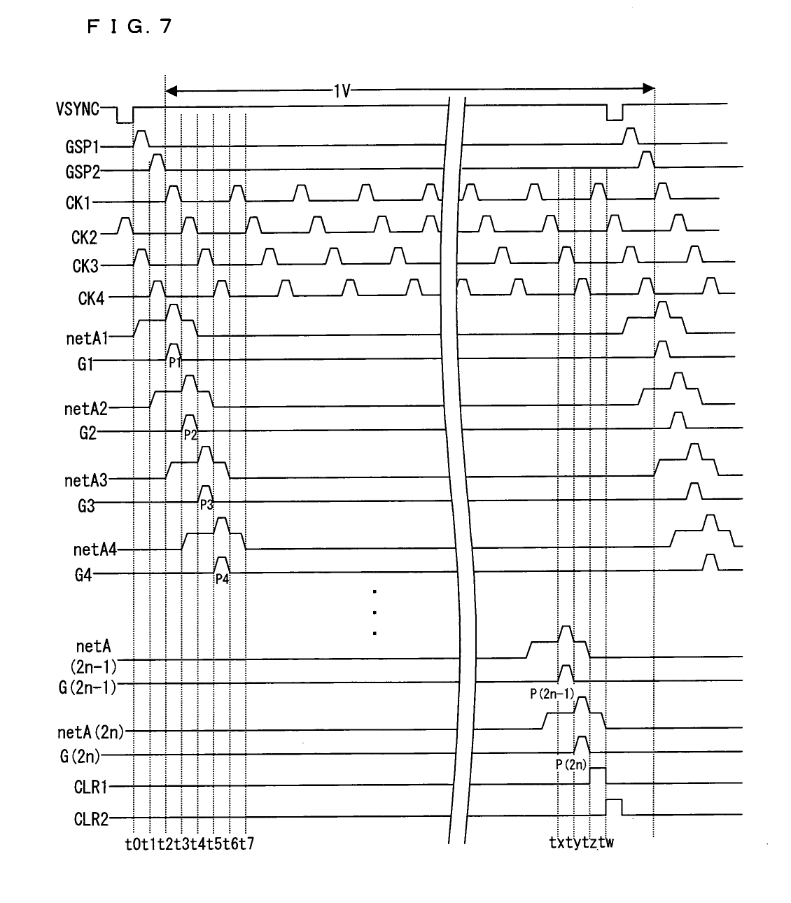

The following describes how the shift registers 10f and 10g operate. FIG. 7 is a timing chart illustrating wave patterns of a vertical synchronizing signal VSYNC, gate start pulse signals GSP1 and GSP2, the first clock signal CK1, the second clock signal CK2, the third clock signal CK3, the fourth clock signal CK4, the gate-on pulse signals Gi (i=1 through 2n), the first clear signal CLR1, and the second clear signal CLR2. In the CK1 through the CK4, a “H” period in one cycle is one clock period, and a “L” period in one cycle is three clock periods. The CK1 through the CK4 are so configured that: (i) when the CK1 falls, the CK2 rises in a synchronous manner; (ii) when the CK2 falls, the CK3 rises in a synchronous manner; (iii) when the CK3 falls, the CK4 rises in a synchronous manner; and (iv) when the CK4 falls, the CK1 rises in a synchronous manner. Further, the GSP2 rises one clock period after the rising of the GSP1. In each of the CK1 through the CK4, its rising portion caused by activation and its returned portion are both sloped.

Initially, at t0 in FIG. 7, the Qf1 increases in electric potential when the GSP1 is moderately activated, thereby causing the Tra of the SC1 to be turned on so that electric potential of the netA1 increases from “L” to “H”. The Trb of the SC1 is accordingly turned on so that the CK1 is supplied to the Qo1. That is, G1 remains “L” at this moment.

At t1, which is one clock period after t0, the GSP1 moderately falls to “L”. However, the electric potential of the netA1 is maintained at “H” by the capacitor C of the SC1, and therefore the Trb of the SC1 is kept on. Further, at t1, the GSP2 is activated so that electric potential of Qf2 increases, thereby causing the Tra of the SC2 to be turned on so that electric potential of the netA2 increases from “L” to “H”. The Trb of the SC2 is accordingly turned on so that the CK2 is supplied to the Qo2. That is, G2 remains “L” at this moment.

At t2, which is one clock period after t1, the CK1 moderately rises so that G1 becomes active and increases to “H”. At this time, the electric potential of the netA1 is set up higher than “H” by the capacitor C. On the other hand, the activation of the G1 increases electric potential of the Qf3, thereby causing the Tra of the SC3 to be turned on so that electric potential of the netA3 increases from “L” to “H”. The Trb of the SC3 is accordingly turned on, thereby causing the CK3 to be supplied to the Qo3. That is, G3 remains “L” at this moment. Further, although the GSP2 moderately falls to “L” at t2, the electric potential of the netA2 is maintained at “H” by the capacitor C of the SC2 and the Trb of the SC2 is still kept on.

At t3, which is one clock period after t2, the CK1 moderately falls to “L” so that the electric potential of the netA1 decreases to “H”. However, since the Trb of the SC1 is still kept on, the CK1 is continuously supplied to the Qo1. As a result, the G1 is inactivated so as to decrease from “H” to “L”, and the G1 is maintained at “L”. Even though the G1 is inactivated and decreases to “L”, the electric potential of the netA3 is maintained at “H” by the capacitor C of the SC3, and therefore the Trb of the SC3 is still kept on. Further, since the CK2 moderately rises at t3, the G2 is also activated and increases to “H”. At this time, the electric potential of the netA2 is set up higher than “H” by the capacitor C. Moreover, at t3, the activation of the G2 increases electric potential of the Qf4, thereby causing the Tra of the SC4 to be turned on so that electric potential of the netA4 increases from “L” to “H”. The Trb of the SC4 is accordingly turned on so that the CK4 is supplied to the Qo4. That is, G4 remains “L” at this moment. Further, since the CK2 moderately rises and the Qo1 of the SC1 is connected to the Vss at t3, the G1 is drawn back to “L”.

At t4, which is one clock period after t3, the CK3 moderately rises so that the G3 is activated and increases to “H”. At this time, the electric potential of the netA3 is set up higher than “H” by the capacitor C. On the other hand, the activation of the G3 increases electric potential of the Qb1, thereby causing the Trd of the SC1 to be turned on so that the netA1 is connected to the Vss and therefore the electric potential of the netA1 decreases from “H” to “L”. As a result, the Trb of the SC1 is turned off, thereby causing the supply of the CK1 to the Qo1 to be stopped. Further, since the CK3 moderately rises at t4, the Tre of the SC1 is turned on so that the Qo1 is connected to the Vss and the electric potential of the Qo1 drops to “L” (the G1 is drawn back to “L”). In the meantime, the CK2 moderately falls to “L” at t4 so that the electric potential of the netA2 decreases to “H”. However, since the Trb of the SC2 is still kept on, the CK2 is continuously supplied to the Qo2. As a result, the G2 decreases from “H” to “L” and becomes inactive. The inactivation of the G2 is maintained. Furthermore, since the CK3 moderately rises at t4 and the Qo2 of the SC2 is connected to the Vss, the G2 is also drawn back to “L”.

At t5, which is one clock period after t4, the CK4 moderately rises so that the G4 is activated and increases to “H”. At this time, the electric potential of the netA4 is set up higher than “H” by the capacitor C. On the other hand, the activation of the G4 increases electric potential of the Qb2, thereby causing the Trd of the SC2 to be turned on so that the netA2 is connected to the Vss and therefore the electric potential of the netA2 decreases from “H” to “L”. As a result, the Trb of the SC2 is turned off, thereby causing the supply of the CK2 to the Qo2 to be stopped. Further, since the CK4 moderately rises at t5, the Tre of the SC2 is turned on so that the Qo2 is connected to the Vss and the electric potential of the Qo2 drops to “L” (the G2 is drawn back to “L”). In the meantime, the CK3 moderately falls to “L” at t5 so that the electric potential of the netA3 decreases to “H”. However, since the Trb of the SC3 is still kept on, the CK3 is continuously supplied to the Qo3. As a result, the G3 decreases from “H” to “L” and becomes inactive. The inactivation of the G3 is maintained. Furthermore, since the CK4 moderately rises and the Qo1 of the SC1 is connected to the Vss at t5, the G1 is also drawn back to “L”. Meanwhile, since the Qo3 of the SC3 is connected to the Vss, the G3 is also drawn back to “L”.

At t6, which is one clock period after t5, the CK1 moderately rises so that G5 is activated and increases to “H”. At this time, electric potential of the netA5 is set up higher than “H” by the capacitor C. On the other hand, the activation of the G5 increases electric potential of the Qb3, thereby causing the Trd of the SC3 to be turned on so that the netA3 is connected to the Vss and therefore electric potential of the netA3 decreases from “H” to “L”. As a result, the Trb of the SC3 is turned off, thereby causing the supply of the CK3 to the Qo3 to be stopped. Further, since the CK1 moderately rises at t6, the Tre of the SC3 is turned on so that the Qo3 is connected to the Vss and the electric potential of the Qo3 drops to “L” (the G3 is drawn back to “L”). In the meantime, the CK4 moderately falls to “L” at t6 so that the electric potential of the netA4 decreases to “H”. However, since the Trb of the SC4 is still kept on, the CK4 is continuously supplied to the Qo4. As a result, the G4 decreases from “H” to “L” and becomes inactive. The inactivation of the G4 is maintained. Furthermore, since the CK1 moderately rises and the Qo3 of the SC3 is connected to the Vss at t6, the G3 is drawn back to “L”. Meanwhile, since the Qo2 of the SC2 is connected to the Vss, the G2 is also drawn back to “L”. Further, since the Qo4 of the SC4 is connected to the Vss, the G4 is also drawn back to “L”.

At t7, which is one clock period after t6, the CK2 moderately rises so that G6 is activated and increases to “H”. At this time, electric potential of the netA6 is set up higher than “H” by the capacitor C. On the other hand, the activation of the G6 increases electric potential of the Qb4, thereby causing the Trd of the SC4 to be turned on so that the netA4 is connected to the Vss and therefore the electric potential of the netA4 decreases from “H” to “L”. As a result, the Trb of the SC4 is turned off, thereby causing the supply of the CK4 to the Qo4 to be stopped. Further, since the CK2 moderately rises at t7, the Tre of the SC4 is turned on so that the Qo4 is connected to the Vss and the electric potential of the Qo4 drops to “L” (the G4 is drawn back to “L”).

Further, at tx, the CK3 moderately rises so that G(2n−1) is activated and increases to “H”. At this time, electric potential of the netA(2n−1) is set up higher than “H” by the capacitor C.

Furthermore, at ty, which is one clock period after tx, the CK4 moderately rises so that G(2n) is activated and increases to “H”. At this time, electric potential of the netA(2n) is set up higher than “H” by the capacitor C. In the meantime, the CK3 moderately falls to “L” at ty so that the electric potential of the netA(2n−1) decreases to “H”. However, since the Trb of the SC(2n−1) is still kept on, the CK3 is continuously supplied to the Qo(2n−1). As a result, the G(2n−1) decreases from “H” to “L” and becomes inactive. The inactivation of the G(2n−1) is maintained.

At tz, which is one clock period after ty, the first clear signal CLR1 is activated and increases to “H” so that the Trd of the SC(2n−1) is turned on and the netA(2n−1) is connected to the Vss. Accordingly, the electric potential of the netA(2n−1) decreases from “H” to “L”. As a result, the Trb of the SC(2n−1) is turned off, thereby causing the supply of the CK3 to the Qo(2n−1) to be stopped. Further, since the CK1 moderately rises, the Tre of the SC(2n−1) is turned on and the Qo(2n−1) is connected to the Vss so that the electric potential of the Qo(2n−1) drops to “L” (the G(2n−1) is drawn back to “L”). In the meantime, the CK4 moderately falls to “L” at tz so that the electric potential of the netA(2n) also decreases to “H”. However, since the Trb of the SC(2n) is still kept on, the CK4 is continuously supplied to the Qo(2n). As a result, the G(2n) decreases from “H” to “L” and becomes inactive. The inactivation of the G(2n) is maintained.

At tw, which is one clock period after tz, the second clear signal CLR2 is activated and increases to “H” so that the Trd of the SC(2n) is turned on and the netA(2n) is connected to the Vss. Accordingly, the electric potential of the netA(2n) decreases from “H” to “L”. As a result, the Trb of the SC(2n) is turned off, thereby causing the supply of the CK4 to the Qo(2n) to be stopped. Further, since the CK2 moderately rises, the Tre of the SC(2n) is turned on and the Qo(2n) is connected to the Vss so that electric potential of the Qo(2n) drops to “L” (the G(2n) is drawn back to “L”).

As such, in the shift register 10f, respective gate-on pulse signals Gi of the shift circuits SCi (i=1, 3, 5, . . . , 2n−1) are activated sequentially for a certain period so that respective pulses P1, P3, . . . , P(2n−1) are outputted sequentially in the order from the first-stage shift circuit SC1 to the final-stage shift circuit SC(2n−1). Further, in the shift register 10g, respective gate-on pulse signals Gi of the shift circuits SCi (i=2, 4, 6, . . . , 2n) are sequentially activated for a predetermined period of time so that respective pulses P2, P4, . . . , P(2n) are outputted sequentially in the order from the first-stage shift circuit SC2 to the final-stage shift circuit SC(2n).

Here, in the shift circuit SCi (i=1 through 2n), in a case where the CK1 through CK4 steeply rises (i.e., rising portions thereof caused by activation are steep) and the CK1 through CK4 steeply falls (i.e., returned portions thereof are steep), such problems may arise that even if the gate terminal of the transistor Trb is set to “L”, current flows between the source and drain terminals of the transistor Trb and that the electric potential of the node Qoi fluctuates due to ON/OFF of the transistors Tre through Trg. This may cause the electric potential of the gate-on pulse signal Gi to become uneven or the like at the time when the gate-on pulse signal Gi is inactive. However, the shift registers 10f and 10g according to the present embodiment are such that the CK1 through CK4 moderately rise (i.e., the rising portions thereof caused by activation are moderate) and the CK1 through CK4 moderately falls (i.e., the returned portions thereof are moderate) so that the above problems can be prevented and a poor gate-on pulse signal hardly occurs.

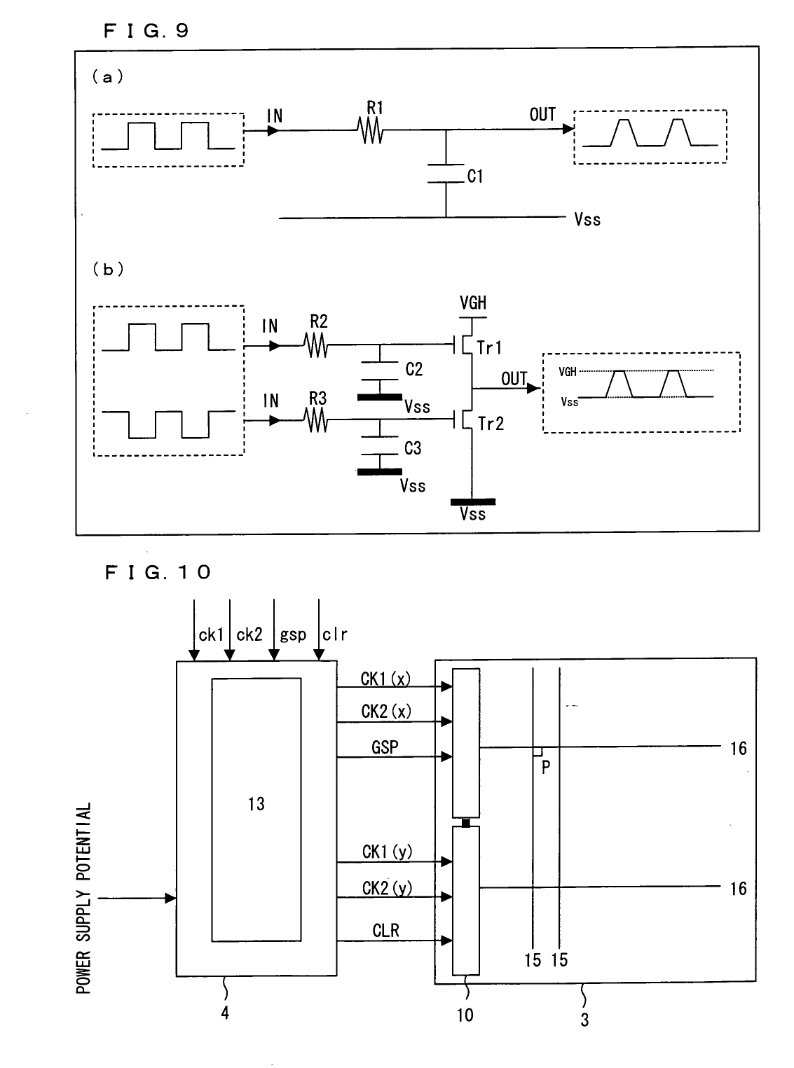

Incidentally, the sloping circuit 13 in FIG. 8 may be configured as a circuit as illustrated in (a) and (b) of FIG. 9, for example. In (a) of FIG. 9, one end of a resistor R1 is connected to IN and the other end of the resistor R is connected to one electrode of a capacitor C1 and to OUT. The other electrode of the capacitor C1 is connected to a Vss. In this configuration, when a rectangular wave signal (clock signal) is supplied to the IN, it is possible to obtain, via the OUT, a signal in which a rising portion caused by activation and a returned portion are both sloped. Further, the configuration illustrated in (b) of FIG. 9 is such that: one end of a resistor R2 is connected to IN1; the other end of the resistor R2 is connected to one electrode of a capacitor C2 and to a gate of a transistor Tr1 (N channel); the other electrode of the capacitor C2 is connected to a Vss; one end of a resistor R3 is connected to IN2; the other end of the resistor R3 is connected to one electrode of a capacitor C3 and to a gate of a transistor Tr2 (N channel); the other electrode of the capacitor C3 is connected to a Vss; a source of the transistor Tr1 is connected to VGH; a source of the transistor Tr2 is connected to a Vss; and drains of the transistors Tr1 and Tr2 are connected to OUT. In this configuration, when respective rectangular wave signals (clock signals) having phases opposite to each other are supplied to the IN1 and the IN2, it is possible to obtain, via the OUT, a signal in which a rising portion caused by activation and a returned portion are both sloped.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The display panel drive circuit and the shift register according to the present invention are preferably applicable to a liquid crystal display device.

1. A display panel drive circuit comprising:
a shift register including unit circuits connected in cascade, each of the unit circuits outputting a signal line selection signal, wherein:
each of the unit circuits receives a clock signal and either a signal line selection signal outputted from another-stage unit circuit or a start pulse signal; and
the clock signal has a rising portion caused by activation of the clock signal, the rising portion being sloped, or a falling portion caused by activation of the clock signal, the falling portion being sloped.

2. The display panel device circuit as set forth in claim 1, wherein:
the start pulse signal has a rising portion caused by activation of the start pulse signal, the rising portion being sloped, or a falling portion caused by activation of the start pulse signal, the falling portion being sloped.

3. The display panel drive circuit as set forth in claim 1, wherein:
the signal line selection signal has a rising portion caused by activation of the signal line selection signal, the rising portion being sloped, or a falling portion caused by activation of the signal line selection signal, the falling portion being sloped.

4. The display panel drive circuit as set forth in claim 1, wherein:
a final-stage unit circuit among the unit circuits receives a clear signal; and
the clear signal has a rising portion caused by activation of the clear signal, the rising portion being sloped, or a falling portion caused by activation of the clear signal, the falling portion being sloped.

5. The display panel drive circuit as set forth in claim 1, wherein:
the clock signal has a sloped returned portion following an activation portion thereof.

6. The display panel drive circuit as set forth in claim 2, wherein:
the start pulse signal has a sloped returned portion following an activation portion thereof.

7. The display panel drive circuit as set forth in claim 3, wherein:
the signal line selection signal has a sloped returned portion following an activation portion thereof.

8. The display panel drive circuit as set forth in claim 4 wherein:
the clear signal has a sloped returned portion following an activation portion thereof.

9. The display panel drive circuit as set forth in claim 1, wherein:
each of the unit circuits other than the final-stage unit circuit includes a set transistor, an output transistor, a reset transistor, a potential supply transistor, and a capacitor, and said each of the unit circuits other than the final-stage unit circuit is configured such that:
either the start pulse signal or a previous-stage signal line selection signal is supplied to a control terminal of the set transistor;
a next-stage signal line selection signal is supplied to a control terminal of the reset transistor;
the clock signal is supplied to a first electrically-conducting terminal of the output transistor;
a clock signal different from the clock signal is supplied to a control terminal of the potential supply transistor;
the output transistor includes a second electrically-conducting terminal that is connected to a first electrode of the capacitor;
the set transistor includes a first electrically-conducting terminal that is connected to the control terminal of the set transistor, and a second electrically-conducting terminal that is connected to a control terminal of the output transistor and to a second electrode of the capacitor;
the reset transistor includes a first electrically-conducting terminal that is connected to the control terminal of the output transistor, and a second electrically-conducting terminal that is connected to a constant potential source;
the potential supply transistor includes a first electrically-conducting terminal that is connected to the second electrically-conducting terminal of the output transistor, and a second electrically-conducting terminal that is connected to a constant potential source; and
the second electrically-conducting terminal of the output transistor serves as an output terminal.

10. The display panel drive circuit as set forth in claim 1, wherein:
the final-stage unit circuit includes a set transistor, an output transistor, a reset transistor, a potential supply transistor, and a capacitor, and the final-stage unit circuit is configured such that:
a previous-stage signal line selection signal is supplied to a control terminal of the set transistor;
the clear signal is supplied to a control terminal of the reset transistor;
the clock signal is supplied to a first electrically-conducting terminal of the output transistor;
a clock signal different from the clock signal is supplied to a control terminal of the potential supply transistor;
the output transistor includes a second electrically-conducting terminal that is connected to a first electrode of the capacitor;
the set transistor includes a first electrically-conducting terminal that is connected to the control terminal of the set transistor, and a second electrically-conducting terminal that is connected to a control terminal of the output transistor and to a second electrode of the capacitor;
the reset transistor includes a first electrically-conducting terminal that is connected to the control terminal of the output transistor, and a second electrically-conducting terminal that is connected to a constant potential source;
the potential supply transistor includes a first electrically-conducting terminal that is connected to the second electrically-conducting terminal, and a second electrically-conducting terminal that is connected to a constant potential source; and
the second electrically-conducting terminal of the output transistor serves as an output terminal.

11. The display panel drive circuit as set forth in claim 1, wherein:
the shift register receives at least two clock signals having different phases; and
one of two clock signals among the at least two clock signals is supplied the unit circuits in odd-numbered stages among the unit circuits, and the other one of the two clock signals among the at least two clock signals is supplied to the unit circuits in even-numbered stages among the unit circuits.

12. The display panel drive circuit as set forth in claim 11, wherein:
the two clock signals among the at least two clock signals have respective phases that are different from each other by half cycle.

13. The display panel drive circuit as set forth in claim 9, wherein:
the set transistor, the output transistor, the reset transistor, and the potential supply transistor are N channel transistors.

14. The display panel drive circuit as set forth in claim 13, wherein:
the first electrically-conducting terminals of the transistors are drain terminals, and the second electrically-conducting terminals of the transistors are source terminals.

15. The display panel drive circuit as set forth in claim 9, wherein:
the first electrically-conducting terminals of the transistors are source terminals, and the second electrically-conducting terminals of the transistors are drain terminals.

16. The display panel drive circuit as set forth in claim 1, further comprising a timing controller for generating the clock signal and the start pulse signal, based on inputted synchronizing signals.

17. The display panel drive circuit as set forth in claim 1, further comprising a sloping circuit for sloping the rising portion of the clock signal which rising portion is caused by activation of the clock signal or the falling portion of the clock signal which falling portion is caused by activation of the clock signal.

18. A liquid crystal display device comprising:
a display panel drive circuit as set forth in claim 1; and
a liquid crystal panel.

19. The liquid crystal display device as set forth in claim 18, wherein:
a shift register of the display panel drive circuit is monolithically provided in the liquid crystal panel.

20. The liquid crystal display device as set forth in claim 19, wherein:
the liquid crystal panel is made from amorphous silicon.

21. The liquid crystal display device as set forth in claim 19, wherein:
the liquid crystal panel is made from polycrystalline silicon.

22. A method for driving a display panel including a shift register including unit circuits connected in cascade, each of the unit circuits outputting a signal line selection signal, said method comprising the steps of:
supplying, to each of the unit circuits, a clock signal and either a signal line selection signal outputted from another-stage unit circuit or a start pulse signal; and
sloping a rising portion or a falling portion of the clock signal, the rising portion or the falling portion being caused by activation of the clock signal.
